(19) United States
(12) Patent Application Publication
(10) Pub. No.: US 2008/0237361 A1
(43) Pub. Date: Oct. 2, 2008

(54) Method and System for Heat Dissipation

(75) Inventor: Tsung-Pin Wang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC CORPORATION, Taipei City (TW)

(21) Appl. No.: 11/695,156

(22) Filed: Apr. 2, 2007

(51) Int. Cl. F24F 7/00; G05D 23/00

(52) U.S. Cl. 236/49.3; 454/184

(57) ABSTRACT

A heat dissipation method is described. A fan module is provided to circulate airflows towards a heat-generating source within a fan speed range. A current temperature of the heat-generating source is measured, wherein the current temperature varies within a temperature range including a lowest critical temperature. The temperature range is divided into a plurality of unique temperatures. The fan speed range is divided into a plurality of unique fan speeds. Each unique fan speed is initially assigned, from low to high, to each unique temperature, from low to high. When the current temperature is lower than the lowest critical temperature, the fan module is driven to rotate at the unique fan speed initially assigned to the current temperature. When the current temperature is higher than the lowest critical temperature, a desired fan speed is dynamically assigned to the current temperature based on a specific mechanism.

### BACKGROUND

1. Field of Invention

The present invention relates to a heat dissipation technology for an electronic device. More particularly, the present invention relates to a method and system for heat dissipation.

2. Description of Related Art

An electronic device consumes power and generates heat during an operating condition. If heat is not removed in time, accumulated heat will destroy or burn electrical components or integrated circuits in the electronic device. One solution is to dissipate the heat by installing a fan module to circulate airflows towards electrical components or integrated circuits, thereby creating an enforced convection to remove accumulated heat.

For example, a fan module is often installed in a casing of a blade server or a desktop computer to dissipate heat generated in the casing. In practice, the fan module is launched by a temperature sensor. When the temperature sensor measures a temperature higher than a predetermined temperature, the fan module begins to operate in responsive to the predetermined temperature. Basically, the fan module rotates at a higher speed when the temperature sensor measures a higher temperature.

Conventionally, a unique fan speed within a fan speed range is assigned to a unique temperature and the fan module rotates at the unique fan speed assigned to the unique temperature. However, it takes a lot of efforts for a heat dissipation system designer to fixedly assign a proper fan speed to each unique temperature. The fan module rotating at a higher speed causes more noises and vibrations, but the fan module rotating at a lower speed may not effectively dissipate accumulated heat. Moreover, such heat dissipation system may not cope with an overheat circumstance, which is likelier to destroy the blade server.

For the forgoing reasons, there is a need for designing an inventive method and system for heat dissipation.

### SUMMARY

A heat dissipation method and system is described. A fan module is provided to circulate airflows towards a heat-generating source within a fan speed range. A current temperature of the heat-generating source is measured by a temperature sensing module, wherein the current temperature varies within a temperature range including a lowest critical temperature. The temperature range is divided into a plurality of unique temperatures. The fan speed range is divided into a plurality of unique fan speeds. Each unique fan speed is initially assigned, from low to high, to each unique temperature, from low to high. When the current temperature is lower than the lowest critical temperature, the fan module is driven to rotate at the unique fan speed initially assigned to the current temperature. When the current temperature is higher than the lowest critical temperature, a desired fan speed is dynamically assigned to the current temperature by an assigning module based on a mechanism.

The mechanism comprises:

When the current temperature is on an increasing trend, the desired fan speed is increased higher than the unique fan speed initially assigned to the current temperature.

When the current temperature is on an increasing trend, the desired fan speed is increased until the current temperature starts to decrease.

When the current temperature is on a decreasing trend and a current fan speed of the fan module is equal to or less than the unique fan speed initially assigned to the lowest critical temperature, the fan speed is kept the same.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a heat dissipation system according to one preferred embodiment of this invention;

FIG. 2 illustrates how a fan speed is assigned to a current temperature according to one preferred embodiment of this invention;

FIG. 3 illustrates an operation flowchart of the heat dissipation system according to one preferred embodiment of this invention; and

FIG. 4 illustrates another operation flowchart of the heat dissipation system according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

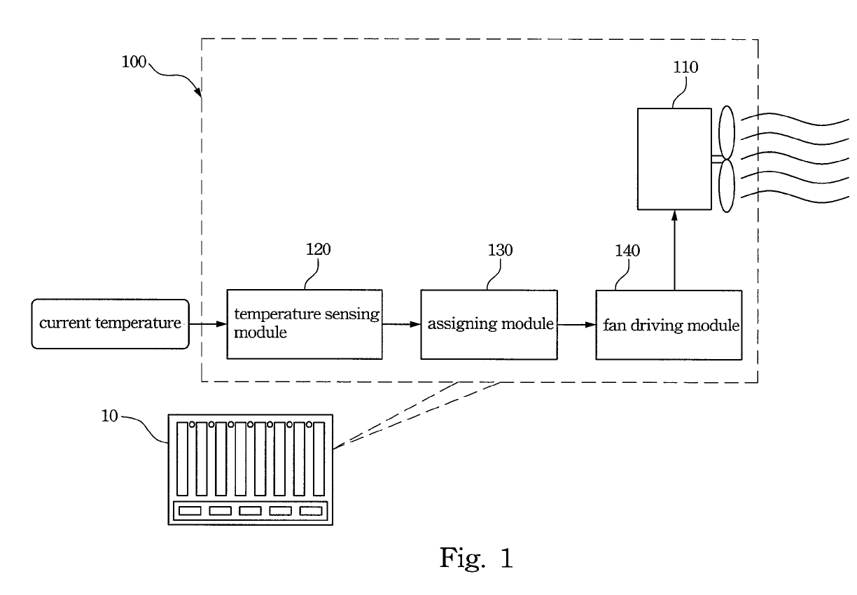

FIG. 1 illustrates a heat dissipation system according to one preferred embodiment of this invention. The heat dissipation system 100 can be installed in a blade server system 10, which includes a plurality of blade servers. The heat dissipation system 100 basically consists of one or more fan modules 110, a temperature-sensing module 120, an assigning module 130, and a fan driving module 140. Each individual component of the heat dissipation system 100 is described below.

The fan module 110 is to circulate airflows towards a heat-generating source, i.e. a plurality of blade servers 10. The fan module 110 may includes one or more fans, and their fan rotating speeds (hereafter FAN_SPEED) might be equally divided as plural different levels, such as FAN_SPEED (1), FAN_SPEED (2) . . . FAN_SPEED (100), for example 100 levels, wherein FAN_SPEED (1) is the lowest fan rotating speed, and FAN_SPEED (100) is the highest fan rotating speed. By “equally divided”, it means that an interval between FAN_SPEED (1) and FAN_SPEED (2) is the same as other interval between any adjacent two FAN_SPEEDs.

The temperature-sensing module 120 is to measure a current temperature (hereafter CURRENT_TEMP) of a heat-generating source in the electronic device 10, and sends a signal containing CURRENT_TEMP to the assigning module 130.

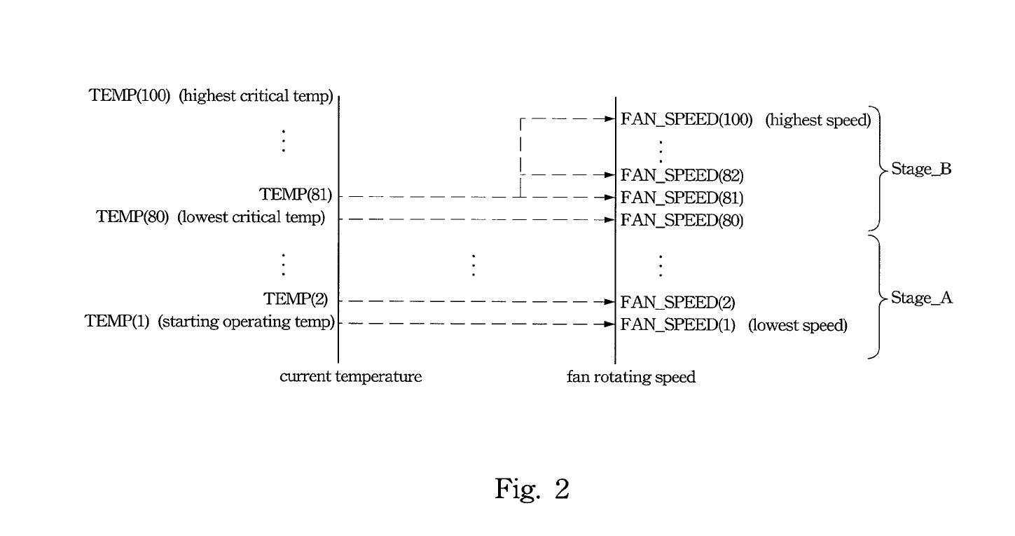

The assigning module 130 is to assign a desired FAN_SPEED to the signal containing CURRENT_TEMP. The assigning module 130 can include a table illustrated as FIG. 2. The table is divided as two stages: STAGE_A (linear stage) and STAGE_B (dynamic stage). CURRENT_TEMP, which ranges from a starting operating temperature to a highest critical temperature, is also equally divided into 100 levels, such as TEMP (1), TEMP (2) . . . TEMP (100). By “equally divided”, it means that an interval between TEMP (1) and TEMP (2) is the same as other interval between any adjacent two TEMPs.

STAGE_A (linear stage) ranges from a starting operating temperature or TEMP(1) to a lowest critical temperature TEMP(80). The fan module does not circulate airflows towards the heat-generating source at a temperature lower than the starting operating temperature. Natural convection can remove heat from the heat-generating source when CURRENT_TEMP is lower than the starting operating temperature. Forced convection generated by the fan module 110 is thus unnecessary. The heat-generating source operates at a temperature higher than the lowest critical temperature is likelier, i.e. 2 or more times, to burn than the heat-generating source operates at a temperature lower than the lowest critical temperature does. In STAGE_A, a FAN_SPEED is initially and fixedly assigned to a CURRENT_TEMP. For example, when CURRENT_TEMP is TEMP (1), the assigned FAN_SPEED is FAN_SPEED (2); when CURRENT_TEMP is TEMP (2), the assigned FAN_SPEED is FAN_SPEED (2); . . . ; when CURRENT_TEMP is TEMP (80), the assigned FAN_SPEED is FAN_SPEED (80).

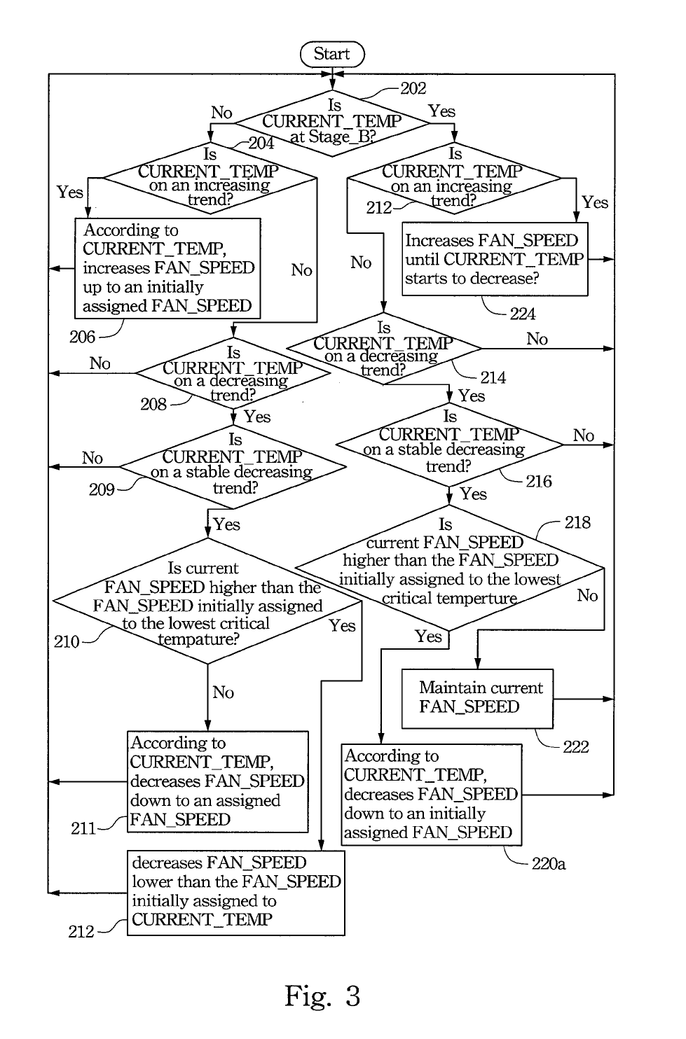

STAGE_B (dynamic stage) ranges from the lowest critical temperature or TEMP(80) to the highest critical temperature or TEMP(100). In STAGE_B, FAN_SPEED is dynamically assigned to a CURRENT_TEMP although FAN_SPEED (81), FAN_SPEED (82), . . . to FAN_SPEED (100), from low speed to high speed, have been initially assigned to TEMP (81), TEMP (82) . . . to TEMP (100), from low temperature to high temperature. For example, CURRENT_TEMP is TEMP (81), FAN_SPEED can be FAN_SPEED (81), FAN_SPEED (82), . . . or FAN_SPEED (100), depending on the rules illustrated in FIG. 3.

The fan driving module 140 drives the fan module 110 to rotate at an assigned FAN_SPEED decided by the assigning module 130. For example, when the assigned FAN_SPEED decided by the assigning module 130 is FAN_SPEED (1), the fan driving module 140 drives the fan module 110 to rotate at FAN_SPEED (1).

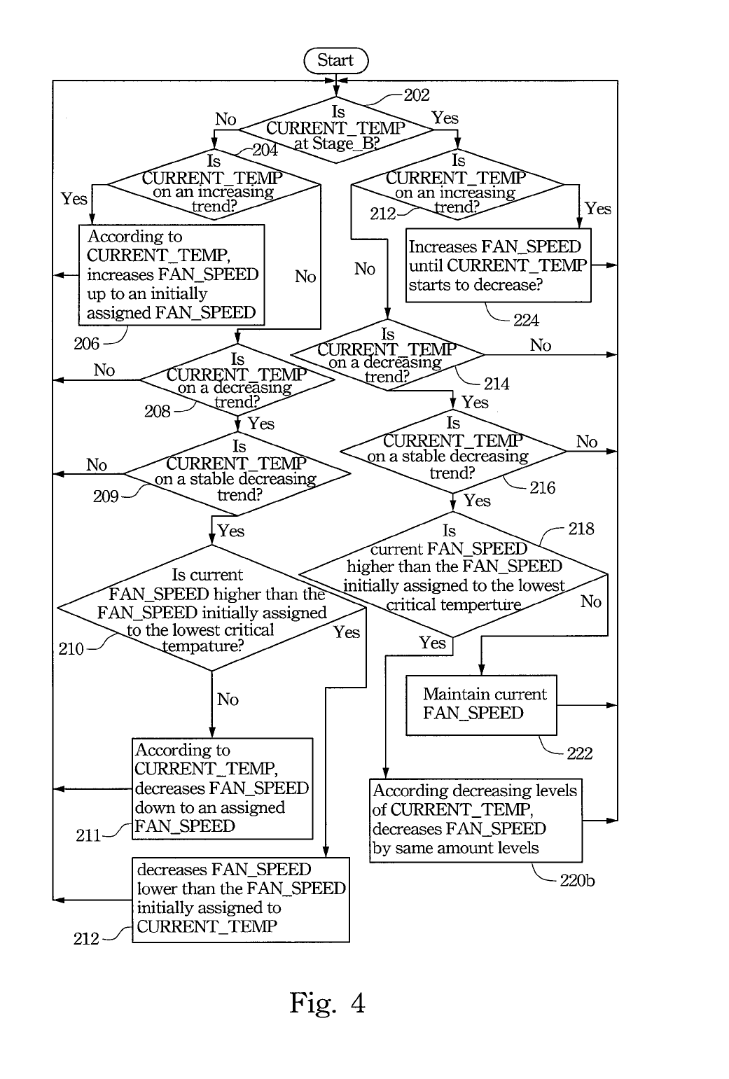

FIG. 3 illustrates an operation flowchart of the heat dissipation system according to one preferred embodiment of this invention. FIG. 4 illustrates another operation flowchart of the heat dissipation system according to one preferred embodiment of this invention. Two operation flowcharts denote mechanisms of the assigning module 130, which assigns a desired FAN_SPEED to CURRENT_TEMP.

Firstly, the assigning module 130 initially assigns FAN_SPEED (1), FAN_SPEED (2), . . . though FAN_SPEED (100), from low speed to high speed, to TEMP (1), TEMP (2), . . . TEMP (100), from low temperature to high temperature.

In STAGE_A, the basic rule is “according to CURRENT_TEMP, increases or decreases FAN_SPEED to an initially assigned FAN_SPEED.” Detailed mechanisms are set forth in step 204, step 206, step 208 and step 210.

In STAGE_B, FAN_SPEED is dynamically assigned according to a CURRENT_TEMP and a gradient of the CURRENT_TEMP. Initially assigned FAN_SPEED is not necessarily a desired FAN_SPEED. Detailed mechanisms are set forth in step 212, step 214, step 216, step 218, step 220 and step 222.

In step 202, the assigning module 130 firstly checks which stage CURRENT_TEMP is located at. When CURRENT_TEMP is higher than the lowest critical temperature (stage_B), go to step 212. When CURRENT_TEMP is lower than the lowest critical temperature (stage_A), go to step 204.

Step 204, step 206, step 208, step 209, step 210, step 211 and step 212 are mechanisms where CURRENT_TEMP is lower than the lowest critical temperature (stage_A). The main rule is that the fan module is driven to rotate at the FAN_SPEED initially assigned to the CURRENT_TEMP. For example (referring to FIG. 2), when CURRENT_TEMP is TEMP (3), the assigned FAN_SPEED is FAN_SPEED (3). When CURRENT_TEMP goes up to TEMP (5) (step 204), the assigned FAN_SPEED goes up to FAN_SPEED (5) (step 206). When CURRENT_TEMP goes down to TEMP (1) (step 208), the assigned FAN_SPEED goes down to FAN_SPEED (1) (step 211).

Step 209 is to check whether the decreasing trend of CURRENT_TEMP is stable. Decreasing 2 or more levels per cycle on CURRENT_TEMP, i.e. from TEMP (10) to TEMP (7), can be called a stable decreasing trend.

Step 210 is to check whether the current FAN_SPEED is on a transition between STAGE_A and STAGE_B. When the current FAN_SPEED is on the transition between STAGE_A and STAGE_B and the CURRENT_TEMP is on the stable decreasing trend, FAN_SPEED can be decreased faster. In step 212, FAN_SPEED is decreased lower than the FAN_SPEED initially assigned to CURRENT_TEMP. For example (referring to FIG. 2), when CURRENT_TEMP is TEMP (79), the current FAN_SPEED is FAN_SPEED (81). When CURRENT_TEMP goes down to TEMP (77) (step 209), the assigned FAN_SPEED goes down to FAN_SPEED (76), which is lower than FAN_SPEED (77) (step 212).

In step 212, the assigning module 130 checks whether CURRENT_TEMP is on an increasing trend or not. When CURRENT_TEMP is on the increasing trend, go to step 224. When CURRENT_TEMP is not on the increasing trend, go to step 214.

In step 224, the heat-generating source, i.e. blade servers, inside the electronic device 10 faces a dangerous condition “CURRENT_TEMP is higher than the lowest critical temperature and on the increasing trend.” Firstly, FAN_SPPED is increased higher than the initially assigned FAN_SPPED. For example (referring to FIG. 2), when CURRENT_TEMP is TEMP (81) and on an increasing trend, the assigned FAN_SPEED should at least be increased up to FAN_SPEED (82), which is higher than assigned FAN_SPEED (81). After step 224, go back to step 202 and step 212 again, then to step 204. This cycle (FAN_SPPED is increased) would not end until CURRENT_TEMP starts to decrease or to the highest FAN_SPEED (such as FAN_SPEED (100)). For example (referring to FIG. 2), when CURRENT_TEMP is TEMP (81) and on an increasing trend, FAN_SPEED is increased up (by circulating step 224=>step 202=>step 212=>step 224) to FAN_SPEED (85) where CURRENT_TEMP starts to decrease. FAN_SPPED can be increased by 2 levels, i.e. from FAN_SPEED (81) to FAN_SPEED (83), or more during one cycle (step 224=>step 202=>step 212=>step 224).

In step 214, the assigning module 130 checks whether CURRENT_TEMP is on a decreasing trend or not. When CURRENT_TEMP is on the decreasing trend, go to step 216.

In step 216, the assigning module 130 further checks whether CURRENT_TEMP is on a stable decreasing trend or not. The term “stable” means that CURRENT_TEMP goes down more than one level, i.e. from TEMP (85) to TEMP (83). When CURRENT_TEMP is on the stable decreasing trend, go to step 218.

In step 218, the assigning module 130 further checks whether FAN_SPPED is higher than the FAN_SPEED assigned to the lowest critical temperature, i.e. FAN_SPPED (80) assigned to TEMP (80) in FIG. 2. When FAN_SPPED is higher than the FAN_SPEED assigned to the lowest critical temperature, go to step 220a or step 220b. When FAN_SPPED is lower than the FAN_SPEED assigned to the lowest critical temperature, go to step 222.

Step 216 and step 218 is to prevent CURRENT_TEMP from going up and down rapidly when CURRENT_TEMP is higher than the lowest critical temperature (stage_B). Because CURRENT_TEMP at stage_B is a dangerous condition (The heat-generating source is likelier to burn), more emphasis should be added on decreasing CURRENT_TEMP than decreasing FAN_SPEED, which decreases noises and vibrations.

In step 220a, FAN_SPEED is decreased down to an initially assigned FAN_SPEED. For example (referring to FIG. 2), when CURRENT_TEMP is TEMP (85) and on a stable decreasing trend and the fan module 110 rotates at FAN_SPEED (87), FAN_SPEED can be decreased down to FAN_SPEED (85).

In step 220b (referring to FIG. 4), FAN_SPEED is decreased down by same levels according to decreasing levels of CURRENT_TEMP. For example (referring to FIG. 2), CURRENT_TEMP is TEMP (85) and the fan module 110 rotates at FAN_SPEED (87). When the CURRENT_TEMP goes from TEMP (85) down to TEMP (82), FAN_SPEED can be decreased from FAN_SPEED (87) down to FAN_SPEED (84) by three levels (same levels as TEMP (85) to TEMP (82)).

In step 222 (FAN_SPPED is equal to or lower than the FAN_SPEED assigned to the lowest critical temperature), FAN_SPEED is maintained the same to keep CURRENT_TEMP on a stable decreasing trend. For example (referring to FIG. 2), when CURRENT_TEMP is TEMP (83) and on a stable decreasing trend and the fan module 110 rotates at FAN_SPEED (79), FAN_SPEED is maintained at FAN_SPEED (79).

Regarding the “CURRENT_TEMP”, it may mean different in a blade server system with several blade servers because each blade server have its own CURRENT_TEMP. Thus, the blade server system would have various CURRENT_TEMPs. For example, at STAGE_A, the term “CURRENT_TEMP” denotes a highest current temperature of all blade servers. At STAGE_B, the term “CURRENT_TEMP” denotes any increasing current temperature of all blade servers in step 224. Otherwise (at STAGE_B), the term “CURRENT_TEMP” denotes all decreasing current temperature of all blade servers. That is, all blade servers' current temperatures are necessarily decreased to satisfy the rules in steps 214, 216 and 218.

In sum, the present invention provides a heat dissipation method and system, which can effectively deal with the high temperature range of a heat-generating source, i.e. higher than the lowest critical temperature, to avoid the heat-generating source (such as an integrated circuit) from malfunctioning or burning.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A heat dissipation method, comprising:
providing a fan module to circulate airflows towards a heat-generating source within a fan speed range;
measuring a current temperature of the heat-generating source, wherein the current temperature varies within a temperature range including a lowest critical temperature, the heat-generating source operates at a temperature higher than the lowest critical temperature is likelier to burn than the heat-generating source operates at a temperature lower than the lowest critical temperature does;
dividing the temperature range into a plurality of unique temperatures, and dividing the fan speed range into a plurality of unique fan speeds;
initially assigning each unique fan speed, from low speed to high speed, to each unique temperature, from low temperature to high temperature;
when the current temperature is lower than the lowest critical temperature, the fan module is driven to rotate at the unique fan speed initially assigned to the current temperature; and
when the current temperature is higher than the lowest critical temperature, an desired fan speed is dynamically assigned to the current temperature based on a mechanism comprising:
when the current temperature is on a decreasing trend and a current fan speed of the fan module is higher than the unique fan speed initially assigned to the lowest critical temperature, the desired fan speed is decreased down to the unique fan speed initially assigned to the current temperature.

2. The heat dissipation method of claim 1, wherein the mechanism further comprises:
when the current temperature is on an increasing trend, the desired fan speed is increased higher than the unique fan speed initially assigned to the current temperature.

3. The heat dissipation method of claim 2, wherein the mechanism further comprises:
when the current temperature is on an increasing trend, the desired fan speed is increased until the current temperature starts to decrease.

4. The heat dissipation method of claim 1, wherein the mechanism further comprises:
when the current temperature is on a decreasing trend and a current fan speed of the fan module is equal to or less than the unique fan speed initially assigned to the lowest critical temperature, the fan speed is kept the same.

5. The heat dissipation method of claim 1, further comprising:
when the current temperature is lower than a starting operating temperature, the fan module stops to rotate, wherein a natural convection is capable of removing heat generated by the heat-generating source operating at a temperature lower than the starting operating temperature.

6. The heat dissipation method of claim 1, wherein intervals between any adjacent two temperatures of the plurality of unique temperatures are equal.

7. The heat dissipation method of claim 1, wherein intervals between any adjacent two fan speeds of the plurality of fan speeds are equal.

8. A heat dissipation method, comprising:
providing a fan module to circulate airflows towards a heat-generating source within a fan speed range;
measuring a current temperature of the heat-generating source, wherein the current temperature varies within a temperature range including a lowest critical temperature, the heat-generating source operates at a temperature higher than the lowest critical temperature is likelier to burn than the heat-generating source operates at a temperature lower than the lowest critical temperature does;
dividing the temperature range into a plurality of unique temperatures, and dividing the fan speed range into a plurality of unique fan speeds;
initially assigning each unique fan speed, from low speed to high speed, to each unique temperature, from low temperature to high temperature; and
when the current temperature is higher than the lowest critical temperature, an desired fan speed is dynamically assigned to the current temperature based on a mechanism comprising:
when the current temperature is on a decreasing trend and a current fan speed of the fan module is higher than the unique fan speed initially assigned to the lowest critical temperature, the desired fan speed is decreased down by the same levels as decreasing levels of the current temperature.

9. The heat dissipation method of claim 1, further comprising:
when the current temperature is lower than the lowest critical temperature, an desired fan speed is assigned to the current temperature based on another mechanism comprising:
driving the fan module to rotate at the unique fan speed initially assigned to the current temperature; and
when the current temperature is on a decreasing trend and a current fan speed of the fan module is higher than the unique fan speed initially assigned to the lowest critical temperature, the desired fan speed is decreased lower than the unique fan speed initially assigned to the current temperature.

10. The heat dissipation method of claim 8, wherein the mechanism further comprises:
when the current temperature is on an increasing trend, the desired fan speed is increased higher than the unique fan speed initially assigned to the current temperature.

11. The heat dissipation method of claim 10, wherein the mechanism further comprises:
when the current temperature is on an increasing trend, the desired fan speed is increased until the current temperature starts to decrease.

12. The heat dissipation method of claim 8, wherein the mechanism further comprises:
when the current temperature is on a decreasing trend and a current fan speed of the fan module is equal to or less than the unique fan speed initially assigned to the lowest critical temperature, the fan speed is kept the same.

13. The heat dissipation method of claim 8, further comprising:
when the current temperature is lower than a starting operating temperature, the fan module stops to rotate, wherein a natural convection is capable of removing heat generated by the heat-generating source operating at a temperature lower than the starting operating temperature.

14. The heat dissipation method of claim 8, wherein intervals between any adjacent two temperatures of the plurality of unique temperatures are equal, and intervals between any adjacent two fan speeds of the plurality of fan speeds are equal.

15. A heat dissipation system, comprising:
a fan module for circulating airflows towards a heat-generating source within a fan speed range;
a temperature sensing module for measuring a current temperature of the heat-generating source, wherein the current temperature varies within a temperature range including a lowest critical temperature, the heat-generating source operates at a temperature higher than the lowest critical temperature is likelier to burn than the heat-generating source operates at a temperature lower than the lowest critical temperature does; and
an assigning module for dividing the temperature range into a plurality of unique temperatures, dividing the fan speed range into a plurality of unique fan speeds, and initially assigning each unique fan speed, from low speed to high speed, to each unique temperature, from low temperature to high temperature,
when the current temperature is lower than the lowest critical temperature, the fan module is driven to rotate at the unique fan speed initially assigned to the current temperature; and
when the current temperature is higher than the lowest critical temperature, an desired fan speed is dynamically assigned to the current temperature based on a mechanism comprising:
when the current temperature is on a decreasing trend and a current fan speed of the fan module is higher than the unique fan speed initially assigned to the lowest critical temperature, the desired fan speed is decreased down to the unique fan speed initially assigned to the current temperature.

16. The heat dissipation system of claim 15, wherein the mechanism further comprises:
when the current temperature is on an increasing trend, the desired fan speed is increased higher than the unique fan speed initially assigned to the current temperature.

17. The heat dissipation system of claim 16, wherein the mechanism further comprises:
when the current temperature is on an increasing trend, the desired fan speed is increased until the current temperature starts to decrease.

18. The heat dissipation system of claim 15, wherein the mechanism further comprises:
when the current temperature is on a decreasing trend and a current fan speed of the fan module is equal to or less than the unique fan speed initially assigned to the lowest critical temperature, the fan speed is kept the same.

19. The heat dissipation system of claim 15, further comprising:
when the current temperature is lower than a starting operating temperature, the fan module stops to rotate, wherein a natural convection is capable of removing heat generated by the heat-generating source operating at a temperature lower than the starting operating temperature.

20. The heat dissipation system of claim 15, further comprising a fan driving module for driving the fan module to rotate at a fan speed assigned to the current temperature by the assigning module.
